(19) United States
(12) Patent Application Publication
(10) Pub. No.: US 2013/0251977 A1
(43) Pub. Date: Sep. 26, 2013

(54) CONDUCTIVE POLYMER FOAM ELASTIC MEMBER

(71) Applicants: Sun-Ki Kim, (US); JOINSET CO., LTD., Ansan-si (KR)

(72) Inventor: Sun-Ki Kim, Gunpo-si (KR)

(73) Assignees: JOINSET CO., LTD., Ansan-si (KR); Sun-Ki Kim, Gunpo-si (KR)

(21) Appl. No.: 13/847,026

(22) Filed: Mar. 19, 2013

(30) Foreign Application Priority Data
Mar. 20, 2012 (KR) 10-2012-0028366
Mar. 28, 2012 (KR) 10-2012-0031679

(51) Int. Cl. H01B 1/12

(52) U.S. Cl. CPC H01B 1/124
USPC 428/308.4

(57) ABSTRACT

A conductive polymer foam elastic body includes a polymer foam body having an open cell structure in which a plurality of pores connected in a thickness direction is exposed on a top surface and a bottom surface therein, and conductive polymer foam elastic coating layers formed by curing and adhering a conductive liquid polymer mixed with conductive powder to the top surface and bottom surface of the polymer foam body and the inside of the pores to be connected to one another.

### REFERENCE TO RELATED APPLICATIONS

This application claims the priority benefit of Korean Patent Application No. 10-2012-0028366 filed on Mar. 20, 2012, and Korean Patent Application No. 10-2012-0031679 filed on Mar. 28, 2012, the entire contents of which are incorporated herein by reference.

### FIELD OF THE INVENTION

The present invention relates to a conductive polymer foam elastic body, and more particularly, to a conductive polymer foam elastic body pressed with a small force, having excellent restoring force, good elasticity, and good conductivity.

Also, the present invention relates to a conductive polymer foam elastic body having conductivity improved while being pressed by an external force.

### BACKGROUND OF THE INVENTION

In order not to send outward electric waves generated by electronic components or modules for high frequency used in electric devices or information communication devices or to protect internal electronic components or modules from external electric waves, electric wave preventing gaskets having excellent restoring force and electrical conductivity, pressed with a small force, are used.

Such electroconductive gaskets have low electric resistance to provide high electrical conductivity, for example, lower than 1 ohm, and have excellent elasticity to be well restored against forces repetitively applied.

According to typical technology, to provide excellent elasticity and restoring force, a metallic layer is formed using electroless plating on the outside of an elastic foam body formed of polyurethane PU with porous to be conductive.

Since the electroconductive elastic foam body has an open cell structure, the metallic layer thinly formed on the outside of the elastic foam body may be easily cut or separated by externally provided repetitive forces in such a way that electrical conductivity of the entire electroconductive elastic foam body becomes lowered and separated metallic plating fragments may be bad influences on peripheral circuits. That is, the metallic layer with no elasticity, exposed outward, is easily cut or separated from the elastic foam body due to externally provided repetitive forces.

Also, when a material used at a relatively low temperature such as polyurethane is used as the elastic foam body, it is difficult to endure a temperature condition of reflow soldering performed at a relatively high temperature.

According to another typical method, a plurality of holes having a certain size is formed in an insulating elastic body such as a nonfoam silicone rubber sheet having elasticity, and then an electroconductive material such as electroconductive silicone rubber is inserted into the holes to be charged with electricity.

However, in this method, it is too expensive to form the plurality of small holes in the nonfoam silicone rubber sheet and it is difficult to uniformly insert the electroconductive silicone rubber into the holes having the relatively small size.

Also, restoring force and elasticity are deteriorated and a force needed to press is increased by metal powder such as carbon, nickel, silver, or copper mixed to improve electrical conductivity.

In the described above, as an example, an elastic body having electrical conductivity has been described. However, since being manufactured by using the described method, a thermally conductive elastic body well transferring heat may have similar disadvantages.

For example, due to ceramic powder such as alumina or boron mixed to improve thermal conductivity or since the silicone rubber sheet is nonfoam, a force needed to press is relatively great and restoring force and elasticity are low.

Accordingly, using the typical methods as described above, it is difficult to manufacture conductive elastic bodies having high electrical conductivity or thermal conductivity, pressed with a small force, and having excellent restoring force and elasticity, that is, conductive silicone foam rubber.

### SUMMARY OF THE INVENTION

An object of the present invention is to provide a conductive polymer foam elastic body, pressed with a small force, having excellent restoring force, good elasticity, and good conductivity.

Another object of the present invention is to provide a conductive polymer foam elastic body capable of being easily manufactured and having excellent productivity.

A still another object of the present invention is to provide a conductive polymer foam elastic body whose conductivity increases in a thickness direction while being pressed by an external force.

A yet another object of the present invention is to provide a conductive polymer foam elastic body whose conductive material is not damaged although external forces are repetitively applied thereto.

A further object of the present invention is to provide a conductive polymer foam elastic body whose heat-resisting temperature is improved.

A still further object of the present invention is to provide a conductive polymer foam elastic body capable of being surface-mounted by vacuum-pickup and being reflow-soldered by solder cream.

A yet further object of the present invention is to provide a conductive polymer foam elastic body using one of conductive polymer elastic coating layers as a skin layer in such a way that the conductive polymer foam elastic body is well vacuum-picked up, has improved waterproofing properties, is protected from impurities such as dusts, has a beautiful appearance, and a top surface and a bottom surface thereof may be easily distinguished from each other.

According to an aspect of the present invention, there is provided a conductive polymer foam elastic body comprising: a polymer foam body having an open cell structure in which a plurality of pores connected in a thickness direction is exposed on a top surface and a bottom surface therein; and conductive polymer foam elastic coating layers formed by curing and adhering a conductive liquid polymer mixed with conductive powder to the top surface and bottom surface of the polymer foam body and the inside of the pores to be connected to one another, wherein the conductive polymer foam elastic body has an open cell structure due to the open cell structure of the polymer foam body, and wherein, when pressing the conductive polymer foam elastic body in the thickness direction, conductivity of the conductive polymer flam elastic body increases due to increase of a contact between the conductive polymer elastic coating layers inside the pore caused by a reduction of a floor area ratio of the pore.

The conductivity may be at least one of thermal conductivity and electrical conductivity.

The polymer foam body may be a conductive polymer foam body plated with a metal on the top surface and the bottom surface thereof and the inside of the pores.

The polymer foam body may comprise a penetration hole penetrating the polymer foam body and having a diameter greater than the pore, and the conductive polymer elastic coating layer may be formed on an inner surface of the penetration hole.

Preferably, polymer resin of the conductive polymer elastic coating layers is a chemical composite different from polymer resin of the polymer foam body.

A heat-resisting temperature of the conductive polymer foam elastic coating layers may be the same as that of the polymer foam body or higher.

Preferably, the conductive polymer foam elastic body satisfies a temperature condition of reflow soldering by the conductive polymer foam coating layers.

Preferably, the conductive polymer elastic coating layers may be formed of nonfoam resin.

The elastic body may further comprise a metal foil, capable of being soldered and adhered to the conductive polymer elastic coating layers by the curing on one of the top surface and the bottom surface of the polymer foam body.

The elastic body may further comprise a conductive elastic member adhered to the conductive polymer elastic coating layers by the curing on another of the top surface and the bottom surface of the polymer foam body.

The elastic body may further comprise conductive elastic members adhered to the conductive polymer elastic coating layers by the curing on the top surface and the bottom surface of the polymer foam body, respectively.

The conductive polymer foam elastic body may be capable of being packed using a reel of tape and vacuum-picked up to be reflow-soldered.

According to another aspect of the present invention, there is provided a conductive polymer foam elastic body comprising: a polymer foam body having an open cell structure with a plurality of pores connected in a thickness direction therein; and conductive polymer elastic coating layers formed by curing and adhering a conductive liquid polymer mixed with conductive powder to one surface and another surface of the polymer foam body and the inside of the pores to be connected to one another, wherein the conductive polymer elastic coating layer formed on the one surface forms a skin layer and the plurality of pores are exposed toward only the other surface, wherein the conductive polymer foam elastic body has an open cell structure due to the open cell structure of the polymer foam body, and wherein, when pressing the conductive polymer foam elastic body in the thickness direction, conductivity of the conductive polymer flam elastic body increases due to increase of a contact between the conductive polymer elastic coating layers inside the pore caused by a reduction of a floor area ratio of the pore.

Preferably, vacuum-pickup is performed at the skin layer.

Preferably, a thickness of the skin layer may be ¼ or less of a thickness of the conductive polymer foam elastic body.

### BRIEF DESCRIPTION OF THE DRAWINGS

The above objects and other advantages of the present invention will become more apparent by describing in detail exemplary embodiments thereof with reference to the attached drawings in which:

FIG. 1 is a view illustrating a conductive polymer foam elastic body according to an embodiment of the present invention;

FIG. 2 is a view illustrating a conductive polymer foam elastic body according to another embodiment of the present invention;

FIG. 3 is a view illustrating a conductive polymer foam elastic body according to still another embodiment of the present invention; and

FIG. 4 is a conductive polymer foam elastic body according to yet another embodiment of the present invention.

### DETAILED DESCRIPTION OF THE INVENTION

Now, exemplary embodiments of the present invention will be described in detail with reference to the accompanying drawings.

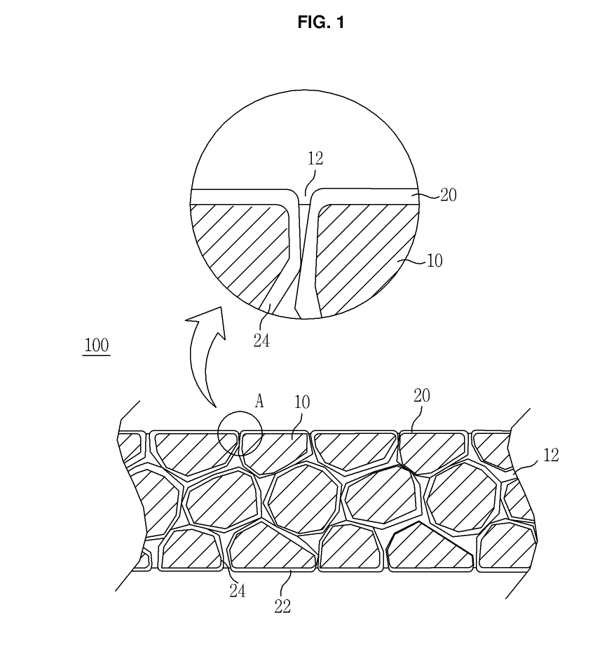

FIG. 1 is a conductive polymer foam elastic body 100 according to an embodiment of the present invention.

The conductive polymer foam elastic body 100 includes a polymer foam body 10 having an open cell structure with a plurality of pores 12 connected in a thickness direction and conductive polymer elastic coating layers formed by curing and adhering a conductive liquid polymer mixed with conductive powder to a top surface and a bottom surface of the polymer foam body 10 and an inner surface of the pores 12 to be electrically or thermally connected to one another.

The pores 12, as well known to a person skilled in the art, are formed by using a chemical foaming agent and the like and are formed in the shape of a cave to be connected to one another in the open cell structure, and the conductive polymer elastic coating layer 24 is formed on the inner surface of the pore 12.

Polymer resin forming the polymer foam body 10 may be a chemical composite different from polymer resin forming the conductive polymer elastic coating layers 20, 22, and 24, and the polymer foam body 10 may be generally but may be conductive if necessary.

Conductivity may be one of thermal conductivity and electrical conductivity or may include both the same. In other words, the conductive polymer elastic coating layers 20, 22, and 24 may have one of thermal conductive powder and electrical conductive powder and may have both the same.

In the case of the conductive polymer elastic coating layer 20, 22, and 24, when the conductive powder is the electrical conductive powder, electrical resistance may be 1 ohm or less and is not limited thereto and may be 108 ohm to easily remove static electricity. Also, when the conductive powder is the thermal conductive powder, thermal conductivity may be 1 W/m·k or more but is not limited thereto.

In the present embodiment, when the conductive polymer foam elastic body 100 is pressed in the thickness direction, conductivity thereof increases. The conductive polymer foam elastic body 100 may be used while being pressed to 5% or more in the thickness direction.

The polymer foam body 10 is manufactured by using a material used at a relatively low temperature and available to easily manufacture an open cell structure. A heat-resisting temperature of the material forming the polymer foam body 10 is lower than a heat-resisting temperature of a material forming the conductive polymer elastic coating layers 20, 22, and 24.

The polymer foam body 10 may have the open cell structure with pores continuously formed in a vertical direction in which skin layers are not formed on the top and bottom surfaces thereof. However, as follows, a skin layer may be formed for a certain purpose.

The polymer foam body 10 may be formed in the shape of a thin sheet having a uniform thickness, and for example, the thickness of the polymer foam body 10 may be 0.2 mm to 3 mm but is not limited thereto.

The polymer foam body 10 may have a flat surface to be easily vacuum-picked up.

As described above, the polymer foam body 10 having a relative low heat-resisting temperature and capable of being easily manufactured as the open cell structure is provided as an inner core.

In the structure as described above, since the polymer foam body 10 having the relative low heat-resisting temperature and capable of being easily manufactured as the open cell structure is used as the inner core, the conductive polymer foam elastic body 100 is pressed with a small force, has excellent restoring force and elasticity, is easily manufactured, and has excellent productivity.

In addition to giving conductivity via the pores 12, a penetration hole vertically penetrating the polymer foam body 10 and having a diameter greater than the pores 12 may be additionally formed with a conductive polymer elastic coating layer formed on an inner surface thereof, thereby increasing conductivity.

The conductive polymer elastic coating layers 20, 22, and 24 may be formed by curing one of an electroconductive liquid polymer with electroconductive powder, such as carbon, nickel, copper, and silver, equally dispersed therein and a thermally conductive liquid polymer with thermally conductive ceramic powder such as alumina and boron, equally dispersed therein. As a liquid polymer, one of silicone rubber and fluoride resin may be used.

The polymer resin for the conductive polymer elastic coating layers 20, 22 and 24 is thermally cured but is not limited thereto. One of the electroconductive and thermally conductive polymers are self-attached to the polymer foam body 10 by being cured.

The conductive polymer elastic coating layers 20, 22, and 24 may be nonfoam coating layers.

A heat-resisting temperature of the conductive polymer elastic coating layers 20, 22, and 24 may be the same as the heat-resisting temperature of the polymer foam body 10 or higher than the same, which makes a heat-resisting temperature of the entire conductive polymer foam elastic body 100 high.

For example, the polymer resin material for the polymer foam body 10 may be PE having low heat-resisting properties and the polymer resin material for the conductive polymer elastic coating layers 20, 22, and 24 may be silicone rubber having high heat-resisting properties and excellent elasticity.

In the case of the structure as described above, when being reflow-soldered or being used at a high temperature, the conductive polymer elastic coating layers 20, 22, and 24 may protect the polymer foam body 10 with the relative low heat-resisting temperature.

Accordingly, it is impossible to satisfy a reflow-soldering condition by using only the polymer foam body 10, but the reflow-soldering condition may be satisfied by using the conductive polymer elastic foam layers 20, 22, and 24 when the conductive polymer elastic foam layers 20, 22, and 24 are adhered to the polymer foam body 10 to be formed as a single body.

Also, according to the structure as described above, it is possible to increase a heat-resisting temperature by using the polymer foam body 10 being easily manufactured with relatively low costs and having the open cell structure with no skin layer formed on top and bottom thereof, thereby providing proper quality at a proper price.

In addition, regardless of the nonfoam conductive polymer elastic coating layers 20, 22, and 24, the conductive polymer foam elastic body 100 may be allowed to have an open cell structure by using the open cell structure of the polymer foam body 10 capable of being easily manufactured at relatively low prices.

Also, due to the open cell structure of the polymer foam body 10, when pressing the conductive polymer foam elastic body 100 in a vertical direction, the conductivity of the conductive polymer foam elastic body 100 is increased. That is, when the thickness of the polymer foam body 10 is reduced by pressing the same, the air is discharged from the pores 12 and a floor area ratio of the pores 12 is reduced in such a way that a conductive distance becomes shorten and a mutual contact between the conductive polymer elastic coating layers 24 increases inside the pores 12, thereby increasing the conductivity.

In this case, the thickness of the conductive polymer elastic coating layer 24 formed on the inner surface of the pore 12 is not particularly limited. However, when filling the entire pore 12, conductivity increases but a force need to press increases and restoring force and elasticity are deteriorated. Accordingly, the conductive polymer elastic coating layer 24 may be formed in such a way that a horizontal cross-sectional area of the conductive polymer elastic coating layer 24 is 90% or less of a horizontal cross-sectional area of the pore 12 when it is assumed that the polymer foam body 10 is cut horizontally. Also, a total weight of the conductive polymer elastic coating layers 20, 22, and 24 may be greater than that of the polymer foam body 10.

Although not shown in the drawings, as another embodiment, the polymer foam body 10 may be an electroconductive polymer foam body in which the top and bottom surfaces thereof and the inner surfaces of the pores 12 are plated with a metal.

The electroconductive polymer foam body, basically, has excellent electrical conductivity, but as described above, may be easily damaged at a metal plating layer due to an outer environment. However, to the electroconductive polymer foam body, the conductive polymer elastic coating layers 20, 22, and 24 are applied, thereby protecting a conductive material from the outside. For example, although external forces are repetitively applied, the metal of the metal plating layer is not broken and fewer fragments thereof are generated.

A method of manufacturing the conductive polymer foam elastic body 100 will no be described as follows.

Electroconductive liquid silicon rubber with copper powder coated with silver having a size of 0.035 mm or less equally dispersed therein is poured over the polyurethane (PU) foam body 10 formed in the shape of a sheet having a thickness of about 2 mm and having an entirely open cell structure including top and bottom surfaces, and then the electroconductive liquid silicone rubber is allowed to fully pass throughout the pores 12 of the polymer foam body 10 by squeeze-printing.

In this case, pressure and time for squeezing the polymer foam body 10 are accurately controlled or an amount of the electroconductive liquid silicone rubber is controlled to allow the conductive polymer foam elastic body 100 to have low heat-resistance or low electrical resistance and to have excellent restoring force and elasticity.

As a result thereof, to the top and bottom surfaces of the polymer foam body 10 and the inner surfaces of the pores 12, the conductive liquid silicone rubber is continuously and uniformly applied.

In this state, when curing the conductive liquid silicone rubber by using heat, the conductive liquid silicone rubber applied to the top and bottom surfaces of the polymer foam body 10 and the inner surfaces of the pores 12 is adhered to the polymer foam body 10 and forms the conductive polymer elastic coating layers 20, 22, and 24, thereby manufacturing the conductive polymer foam elastic body 100.

The weights of the conductive polymer elastic coating layers 20, 22, and 24 may be 60% or more of the weight of the entire the conductive polymer foam elastic body 100.

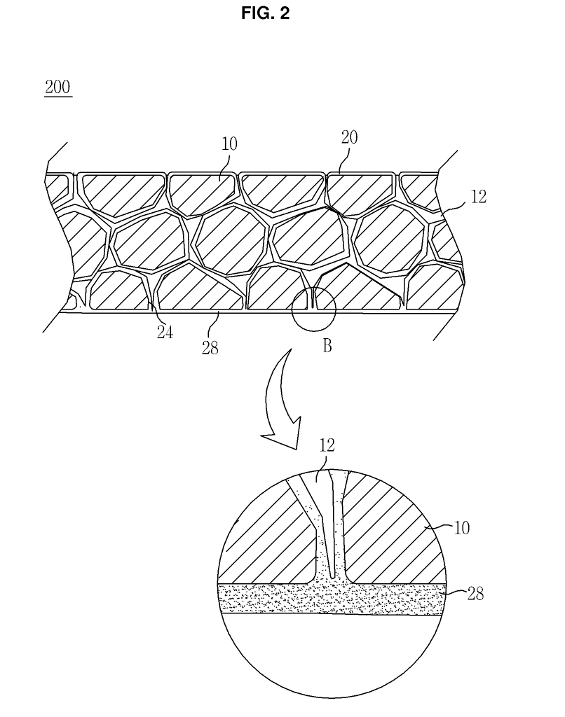

FIG. 2 is a view illustrating a conductive polymer foam elastic body 200 according to another embodiment of the present invention.

In the present embodiment, a nonfoam conductive polymer elastic coating layer 22 formed on a bottom surface of the polymer foam body 10 forms a skin layer 28 and a plurality of the pores 12 is connected only to a top surface of the polymer foam body 10.

A thickness of the skin layer 28 may be ¼ or less of a thickness of the conductive polymer foam elastic body 200. When being thicker than this, not only a pressing force and a weight thereof increase but a large amount of a material is consumed, which is uneconomical and an elastic restoring force becomes deteriorated.

A skin layer may be formed by using a film base for transferring the polymer foam body 10 in a manufacturing process. That is, to mass-produce the conductive polymer foam elastic bodies 200 by using the polymer foam bodies 10 having a small thickness and being easily torn, the conductive polymer foam elastic bodies 200 are manufactured by using a roll to roll method using a film base.

In detail, the polymer foam body 10 is added onto a polymer film such as a PET film to be supplied as a roll to smoothly transfer the polymer foam body 10 and is continuously impregnated with conductive liquid silicone rubber containing conductive powder in such a way that the conductive liquid silicone rubber fully passes throughout the pores 12 of the polymer foam body 10. Then, a part of the conducive liquid silicone rubber percolating the pores 12 of the polymer foam body 10 is continuously squeezed and removed by a roll or a blade and then is continuously thermally processed and cured, thereby continuously manufacturing the conductive polymer foam elastic bodies 200.

As described above, when the polymer foam body 10 is formed on a film to manufacture the conductive polymer foam elastic body 200 by using the roll to roll method, on a part in contact with the film for the polymer foam body 10, the pores 12 is filled with the conductive liquid silicone rubber transferred downwardly due to the force of gravity, thereby forming the skin layer 28.

That is, the skin layer 28 is a nonfoam conductive elastic coating layer with no pores 12, in which the density of the contained conductive powder increases, thereby increasing conductivity.

In the case of the roll to roll method, since a polymer film is generally pulled, a slip may occur between the polymer film and the polymer foam body 10 added thereto not to be pulled. To prevent this, the polymer film having a self-adhesive adhesive (PSA) on one surface thereof may be used and the polymer foam body 10 may be added to the adhesive.

On the other hand, referring to FIG. 2, the conductive powder equally dispersed in conductive liquid polymers are transferred downwardly by own weight thereof in such a way that the density of the conductive powder in the skin layer 28 largely increases, thereby increasing the conductivity.

According to the configuration as described above, since the pores 12 are blocked in the skin layer 28, vacuum-pickup is well performed at the skin layer 28, water proofing properties are improved, impurities such as dusts are prevented, and an appearance thereof is beautiful.

Also, due to the increase of the density of the conductive powder in the skin layer 28 by the own weight thereof, horizontal conductivity is largely increased.

Also, due to a difference between degrees of reflecting light by the skin layer 28 and an opposite surface, it is possible to easily distinguish the top and bottom surfaces with naked eyes.

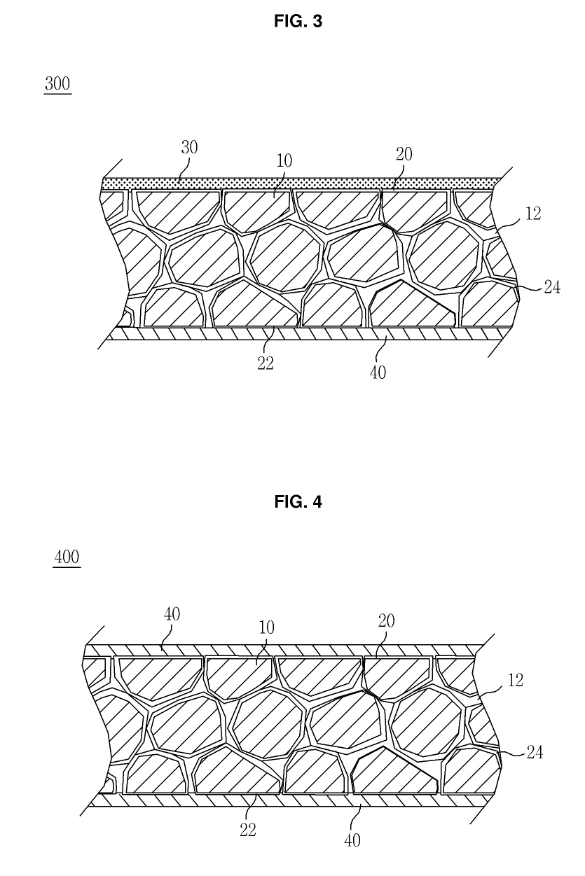

FIG. 3 is a view illustrating a conductive polymer foam elastic body 300 according to still another embodiment of the present invention.

According to the conductive polymer foam elastic body 300, a metal foil 30 capable of being soldered is adhered to the top surface of the polymer foam body 10 by curing the conductive polymer elastic coating layer 20 and a nonfoam conductive elastic member 40 such as conductive silicone rubber is adhered to the bottom surface thereof by curing the conductive polymer elastic coating layer 22.

In this case, the metal foil 30 and the nonfoam conductive elastic member 40 may be deposited on the bottom surface and the top surface, respectively, and may be deposited on any one thereof.

Also, the nonfoam conductive elastic member 40 may be formed of the same material as the conductive polymer elastic coating layers 20 and 22.

Since the pores 12 in the polymer foam body 10 are not exposed outside the top and bottom surfaces of the polymer foam body 10 by the nonfoam conductive elastic member 40 and the metal foil 30, an appearance thereof is beautiful and it is possible to prevent water and impurities passing through the top and bottom surfaces.

In a manufacturing process, conductive liquid silicone rubber is applied to the top and bottom surfaces of the polymer foam body 10 and the metal foil 30 and the nonfoam conductive elastic member 40 are located on the top and bottom surfaces, respectively, and cured as a single body, thereby adhering the metal foil 30 and the nonfoam conductive elastic member 40 to the conductive polymer elastic coating layers 20 and 22.

Conductivity of the nonfoam conductive elastic member 40 may be one of electrical conductivity and thermal conductivity or may be both the same.

The conductive polymer foam elastic body 300 with the metal foil 30 formed on one side thereof is reel-packed by a carrier tape and may be reflow-soldered by using a surface mounting process.

FIG. 4 is a view illustrating a conductive polymer foam elastic body 400 according to yet another embodiment of the present invention.

In the present embodiment, the nonfoam conductive elastic members 40 such as conductive silicone rubber are adhered to the top and bottom surfaces of the polymer foam body 10, respectively, by curing the conductive polymer elastic coating layers 20 and 22.

According to the structure as described above, since the nonfoam conductive elastic members 40 having excellent conductivity and elasticity are deposited on both the top and bottom surfaces of the polymer foam body 10, not only the conductivity increases but elasticity is improved comparing with the embodiment of FIG. 3.

Since the pores 12 in the polymer foam body 10 are not exposed outside the top and bottom surfaces of the polymer foam body 10 by the nonfoam conductive elastic members 40, an appearance thereof is beautiful and it is possible to prevent water and impurities passing through the top and bottom surfaces.

While the present invention has been described in detail, it should be understood that various changes, substitutions and alterations can be made hereto without departing from the spirit and scope of the invention as defined by the appended claims.

What is claimed is:

1. A conductive polymer foam elastic body includes:
a polymer foam body having an open cell structure in which a plurality of pores connected in a thickness direction is exposed on a top surface and a bottom surface therein; and
conductive polymer foam elastic coating layers formed by curing and adhering a conductive liquid polymer mixed with conductive powder to the top surface and bottom surface of the polymer foam body and the inside of the pores to be connected to one another,
wherein the conductive polymer foam elastic body has an open cell structure due to the open cell structure of the polymer foam body, and
wherein, when pressing the conductive polymer foam elastic body in the thickness direction, conductivity of the conductive polymer flam elastic body increases due to increase of a contact between the conductive polymer elastic coating layers inside the pore caused by a reduction of a floor area ratio of the pore.

2. The conductive polymer foam elastic body of claim 1, wherein the conductivity is at least one of thermal conductivity and electrical conductivity.

3. The conductive polymer foam elastic body of claim 1, wherein the polymer foam body is a conductive polymer foam body plated with a metal on the top surface and the bottom surface thereof and the inside of the pores.

4. The conductive polymer foam elastic body of claim 1, wherein the polymer foam body includes a penetration hole penetrating the polymer foam body in a thickness direction and having a diameter greater than the pore, and
wherein the conductive polymer elastic coating layer is formed on an inner surface of the penetration hole.

5. The conductive polymer foam elastic body of claim 1, wherein polymer resin of the conductive polymer elastic coating layers is a chemical composite different from polymer resin of the polymer foam body.

6. The conductive polymer foam elastic body of claim 1, wherein a heat-resisting temperature of the conductive polymer foam elastic coating layers is the same as that of the polymer foam body or higher.

7. The conductive polymer foam elastic body of claim 1, wherein the conductive polymer foam elastic body satisfies a temperature condition of reflow soldering by the conductive polymer foam coating layers.

8. The conductive polymer foam elastic body of claim 1, wherein the conductive polymer elastic coating layers are formed of nonfoam resin.

9. The conductive polymer foam elastic body of claim 1, further including a solderable metal foil adhered to the conductive polymer elastic coating layers by the curing on one of the top surface and the bottom surface of the polymer foam body.

10. The conductive polymer foam elastic body of claim 9, further including a conductive elastic member adhered to the conductive polymer elastic coating layers by the curing on another of the top surface and the bottom surface of the polymer foam body.

11. The conductive polymer foam elastic body of claim 1, further including conductive elastic members adhered to the conductive polymer elastic coating layers by the curing on the top surface and the bottom surface of the polymer foam body, respectively.

12. The conductive polymer foam elastic body according to claim 9, wherein the conductivity is one of thermal conductivity and electrical conductivity.

13. The conductive polymer foam elastic body according to claim 9, wherein the conductive polymer foam elastic body is capable of being packed using a reel of tape and vacuum-picked up to be reflow-soldered.

14. A conductive polymer foam elastic body includes:
a polymer foam body having an open cell structure with a plurality of pores connected in a thickness direction therein; and
conductive polymer elastic coating layers formed by curing and adhering a conductive liquid polymer mixed with conductive powder to one surface and another surface of the polymer foam body and the inside of the pores to be connected to one another,
wherein the conductive polymer elastic coating layer formed on the one surface forms a skin layer and the plurality of pores are exposed only on the other surface,
wherein the conductive polymer foam elastic body has an open cell structure due to the open cell structure of the polymer foam body, and
wherein, when pressing the conductive polymer foam elastic body in the thickness direction, conductivity of the conductive polymer flam elastic body increases due to increase of a contact between the conductive polymer elastic coating layers inside the pore caused by a reduction of a floor area ratio of the pore.

15. The conductive polymer foam elastic body of claim 14, wherein vacuum-pickup is performed at the skin layer.

16. The conductive polymer foam elastic body of claim 14, wherein a thickness of the skin layer is ¼ or less of a thickness of the conductive polymer foam elastic body.
